(19) United States
(12) Patent Application Publication
(10) Pub. No.: US 2019/0104707 A1
(43) Pub. Date: Apr. 11, 2019

(54) INVISIBLE RADIO FREQUENCY LEASH SYSTEM

(71) Applicant: Gregory G. Gotts, Oakland, CA (US)

(72) Inventor: Gregory G. Gotts, Oakland, CA (US)

(21) Appl. No.: 15/912,538

(22) Filed: Mar. 5, 2018

Related U.S. Application Data
(63) Continuation-in-part of application No. 15/396,621, filed on Dec. 31, 2016.

(51) Int. Cl. A01K 15/02; A01K 27/00

(52) U.S. Cl. CPC A01K 15/023; G01S 19/01; A01K 27/009

(57) ABSTRACT

A invisible radio frequency (RF) leash system is provided for controlling and confining an owner's dog to a predefined distance or radius. The system comprises a radio frequency (RF) smartphone hardware interface or dongle, electronic dog collar module, and mobile device application user interface. The system RF hardware preferably operates on the 433 MHz, 2.4 GHz, or other radio frequencies. The dog owner sets the distance and stimulus modality via the mobile device application and is provided with automatic correction when the dog reaches the perimeter boundary and the dog is confined to the perimeter. The RF hardware interface or dongle is comprised of radio hardware for distance ranging, data-link, and receiving information from the dog collar module. The dog collar tracks activity and location with a GPS module and transmits RF distance ranging signals, location, and activity data to the RF dongle for display on the owner's mobile device application. The dog collar provides electric shock, vibrational, audio or other correction stimulus upon reaching the predefined distance or radius perimeter boundary and ensures that the dog remains within the perimeter.

### BACKGROUND

For the dog owner looking to provide an electronic collar means for training their dog to stay within the yard or stay out of certain areas, there are a few currently available options. First is the in-ground electric fence, in which the owner physically buries or strings along a cable around the desired perimeter boundary. These systems provide a correction, i.e., audible tone, vibration, or electric shock, via the dog's electronic collar receiver. In-ground electric fence systems are powered by a wall outlet power adapter, and fence transmitter box. The owner sets up the system perimeter by burying or stringing the boundary wire along the edge of the yard and connecting the wire loop to the transmitter mounted near an electrical outlet. As the dog approaches or crosses the physical boundary wire perimeter, the collar receiver picks up the signal from the transmitter and delivers a correction or electric shock to the dog. These in ground electric fence systems typically allow the boundary zone around the buried wire cable to be adjusted from a few inches to a few feet. The drawback to these systems is the fact that one has to dig up the yard to bury the cable, the complicated planning and setup process, and inability to change, alter, adjust or move the perimeter after installation.

A second option available for dog owner's is wireless systems, which are available in a few varieties. Most common are dedicated handheld transmitter and dog collar receiver systems. The owner attaches an electronic collar to the dog and pushes a button on the handheld transmitter to deliver a vibration, beep, static shock to correct the dog's behavior. These systems are advertised with operating ranges up to a few hundred yards and typically operate on the 500-900Mhz frequency spectrum. Another similar wireless system utilizes the owner's smartphone as the transmitter over Bluetooth radio frequencies. The owner pairs the electronic collar with his or her smartphone and launches an iOS or Android app in which the owner may push a button to deliver stimulus or electric shock corrections. However, the range of these Bluetooth systems is a lot less than those with a dedicated handheld transmitter. Whether using the Bluetooth or dedicated transmitter option, the owner is still required to give full attention to the dog's behavior, under constant watch, and manually provide correction by pushing a button.

There are still other wireless systems available which provide functionality similar to the in-ground fence options by allowing the owner to set up a perimeter boundary for the automatic delivery of corrections stimulus. These wireless systems typically comprise a wall powered, fixed, radio transmitter base station and an electronic collar receiver. The owner sets the distance for the dog's perimeter boundary on the base station and when the dog reaches the preset distance setting, the collar delivers a correction. These systems typically have range limits of around 100 feet and operate on radio frequencies of 17.5 kHz or over typical Wi-Fi frequency ranges. These systems require cumbersome adjustment and careful placement and positioning of the radio transmitter base station and experimentation with the boundary control adjustment to set the desired distance to the collar. Most devices require the owner to physically walk the yard with the dog collar to set and adjust the boundary, re-adjust the base station, and manually place “flags” to mark the boundary. Additionally, these system are not very portable as the base stations are primarily designed to operate from wall outlet power sources and the complicated setup process would have to be repeated each time the owner changes locations. Therefore, there is a need for a better user experience and well-designed system to train and control a dog's behavior.

### SUMMARY

The presently described system provides radio hardware to be operated by the dog owner's smartphone or mobile device and a wireless radio frequency (RF) connection to the dog's electronic corrections collar. The radio hardware connects to the owner's smartphone and preferably provides 433 MHz and 2.4 GHz radio frequency connection, data-link, and distance ranging to the dog collar with an up to one-half a mile (½ mile) operating radius. The radio hardware may preferably be embodied in a smartphone dongle style form factor with connection over the smartphone data port, lighting port, USB, micro-USB, or paired wirelessly over Bluetooth or Wi-Fi. In a preferred embodiment, the dog owner plugs in the radio frequency (RF) dongle to the owner's smartphone and launches the iOS, Android, or other smartphone operating system mobile application. In the application user interface, the owner sets the maximum desired distance to which the dog is permitted to travel away from the owner. For example, the owner may set the distance at one-hundred feet (100-feet) and set the corrections stimulus to provide an electric shock, vibration, or audible tone. When the dog reaches the max distance setting, the collar provides correction stimulus, and the dog returns and stays within the permitted perimeter boundary.

The distance between the dog and the owner is continuously ranged and monitored over the system's 433 MHz and 2.4 GHz RF hardware. The smartphone app. continuously requests a live distance ranging measurement from the RF dongle input/output interface. In a preferred embodiment, the distance ranging prompt simultaneously initiates the quartz crystal frequency generator, frequency counter integrated circuit (IC), and the transmission of a radio signal over the dongle's 433 MHz/2.4 GHz transmission (Tx) radio module. The RF signal is transmitted to the dog's collar and is received by the 433 MHz/2.4 GHz receiver (Rx) radio module. The signal is then transmitted back by the collar RF hardware and returned to the dongle receiver which stops the frequency counter IC. By calculation of the speed of light for radio waves and the time for the RF signal to travel between the collar and dongle, as measured by the counter IC, the distance to the collar may be determined. The distance to the dog collar is continuously calculated, ranged, monitored, and displayed by the smartphone app. user interface and is used for providing correction stimulus as configured by the dog owner. The RF radio hardware is preferably designed to provide accurate distance ranging up to one-half a mile (½ mile) away. Additionally, the dog collar may be provided with a GPS receiver to provide location information and activity tracking to the dog owner's smartphone app. over the RF dongle's receive/transmit (Rx/Tx) data-link.

### DESCRIPTION OF THE DRAWINGS

FIG. 1 is a view of the invisible radio frequency (RF) leash system with the RF dongle hardware attached to the owner's mobile device running the system mobile device application and the dog wearing the electronic dog collar module.

FIG. 2 is a view of the invisible radio frequency (RF) leash system with the RF dongle attached to the owner's smartphone, the owner taking the dog for a walk, and the dog wearing the electronic dog collar module, and the dog being controlled and confined to a user-defined radius or distance.

FIG. 3 is a view of the invisible radio frequency (RF) leash system with the RF dongle attached to the owner's smartphone, the dog wearing the electronic dog collar module, the owner using the system mobile device application and user interface on a mobile device, and the dog being controlled and confined with correction stimulus to a user-defined radius or distance.

FIG. 4 is a view of the invisible radio frequency (RF) leash system with the RF dongle shown individually and integrated with the smartphone mobile device, the mobile device application user interface, and the electronic dog collar module and correction stimulus interface.

FIG. 5 is a view of the invisible radio frequency (RF) leash system being deployed at a typical residential property where the dog is controlled and confined to a predefined radius or distance, with various correction stimulus, as configured and adjusted with the mobile device application user interface.

FIG. 6 is a view of the invisible radio frequency (RF) leash system showing GPS location tracking, user-defined radius or distance setting, correction stimulus modalities, and user profiles functionality.

FIG. 7 is a view of the invisible radio frequency (RF) leash system showing the RF hardware attached to the user's smartphone device running the mobile application user interface and configuring the desired distance or radius perimeter boundary for controlling and confining the dog.

### DETAILED DESCRIPTION

The presently described system provides a means to control and confine a dog's movement to within a user-defined perimeter, distance, or radius through preferred embodiments of a smartphone application user interface, radio frequency (RF) dongle, and electronic dog collar. In a preferred embodiment, the dog owner launches the smartphone app., sets the maximum permitted distance or radius for the dog, and the desired corrections stimulus, whether a mild to strong attention getting electric shock, vibration, or audible tone. When the dog reaches the maximum permitted distance, radius, or perimeter boundary, the dog collar delivers the correction stimulus, and the dog returns to stay within the perimeter boundary. The system may preferably operate with radio frequency hardware on the 433 MHz and 2.4 GHz frequency spectrum. The system may alternatively operate on other frequencies. The RF hardware and signal strength power will additionally be designed to provide accurate distance and ranging information up to one-half a mile (½ mile) distance, or radius, from the RF dongle to the dog collar. The smartphone based app. user interface allows the dog owner to see current, real-time, live streaming distance ranging information and the ability to adjust, extend, or shorten the distance or radius of the perimeter boundary. In this respect, the system operates similar to a conventional leash with functionality that allows the dog owner to control the distance between the owner and the dog. However, the presently described system allows for control and confinement distances much larger than conventional leashes, with distances upwards of one-half a mile. Furthermore, unlike currently available wireless fence systems, the presently described system is entirely mobile and allows the owner and dog to move freely about unrestricted. Additionally, the dog collar is provided with a GPS transceiver for location and activity tracking, which may be streamed over the system's RF hardware data-link and displayed in the app. user interface.

In a preferred embodiment, the system may determine the distance to the owner's dog by measuring the time of travel of radio waves between the RF dongle and the collar. As radio waves travel at the speed of light (i.e., 2.998×10^{10̂8} meters/second, or 9.836×10̂8 feet/second) the system may calculate the distance to the dog by measuring the time it takes the radio signal to travel from the RF dongle to the collar. The RF dongle preferably measures the time with a crystal frequency generator with a given clock rate and counter integrated circuit (IC). The system will preferably utilize a quartz crystal frequency generator with high enough oscillating frequency and counters with clock frequencies for enough precision and accuracy for calculating distance measurements to within a few feet. In a preferred embodiment, the system may use 50 MHz, 100 MHz, 1 GHz, 5 GHz or higher frequency generators with corresponding counter integrated circuits that may accept and count clock frequency inputs of that order and magnitude. For example, the system RF dongle may initiate the distance ranging signal by firing the crystal frequency generator, starting the counter IC, and sending the first transmission (Tx) radio signal out to the dog collar. The dog collar receiver (Rx) receives the first signal and sends back a second transmission (Tx) to the RF dongle, which when received, stops the counter IC. The time of travel is calculated by the known clock rate of the frequency generator and counter measurement. The calculation of distance is done by the speed of light distance formula with the time measurement in nanoseconds, i.e., speed=(distance)/(time), or distance=(speed)×(time). For example, if the radio signal has taken T nanoseconds to travel from the RF dongle, to the dog collar and back, the distance may be calculated as such: T nanoseconds, multiplied by the speed of light, and divided in half, to account for the travel time to the dog collar, and not the return trip.

In a preferred embodiment, the RF dongle and electronic dog collar system may comprise a radio transmitter and receiver. The system may provide an RF dongle with input/output interface for the smartphone or mobile device, a microcontroller, and radio frequency (RF) transmitter and receiver. The RF transmitter may comprise a signal information input interface, transducer, diodes, voltage amplifier, power amplifier, modulator, bias voltage, band pass filter, multiplier mixer, voltage controlled oscillator, linear amplifier and antenna. The RF receiver may comprise an antenna, filter, low noise amplifier, diodes, diode detector, mixer, oscillator, lowpass filter, bandpass filter, intermediate frequency amplifier, demodulator, capacitor, detector, transducer, and signal information output interface. The RF dongle and dog collar may preferably comprise an RF transmitter and receiver to operate on 433 MHz, 2.4 GHz, and other frequencies as needed for accurate distance ranging and data-link functionality for the system. The RF hardware may preferably comprise features for amplification, gain, dynamic range, sensitivity, noise power, and frequency selectivity for strong and uninterrupted connection between the system transmitters and receivers. The RF hardware antenna may preferably be embodied in a wire antenna, dipole/loop, dielectric rod, or ultra-low profile multiple-input multiple-output chip antenna, and be supplied power through a transmission line and waveguide and will radiate or receive RF energy at 433 MHz, 2.4 GHz, or other frequencies. The system hardware receiver antenna will intercept the power from the system generated RF energy waves, and generate a voltage at the circuit terminal for further processing. For maximum antenna gain, the system RF hardware will be provided with an antenna with high directivity. Additionally, to achieve diversity gain and high wireless data rates, the system may utilize adaptive antenna combining with a multiple input multiple output approach.

In a preferred embodiment, the system RF dongle, dog collar, and radio transmitters (Tx) and receivers (Rx) may preferably use oscillators with high enough oscillating frequency and counters with high clock frequencies for high enough precision and accuracy for calculating distance measurements to within a few feet. The system oscillators are preferably the frequency determining elements of the system transmitters, receivers, and clock measurements by dividing time into regular intervals for the preferred distance, speed, time formula and RF distance ranging functionality. The system oscillators may be embodied with positive feedback oscillators, quartz crystal frequency generators, parallel or series capacitor/inductor (LC) circuits, dielectric resonator, or other electromechanical resonators. In preferred embodiment, the system oscillators convert direct current from the system's power supply, which may be embodied an integrated rechargeable battery, to an alternating current signal. The RF hardware may preferably comprise voltage controlled oscillators (VCO) for the up and down conversion of transmitted and received distance ranging signals, GPS data signal, and other information sent between the system radio transceivers. The VCO is preferably used for the system's RF power over a frequency range, i.e., 433 MHz, 2.4 GHz, etc. The system's oscillator preferably generates a local oscillator signal for the periodic output signal at a specific tuneable frequency for the RF hardware's 433 MHz, 2.4 GHz, or other operating frequency ranges. The oscillator may preferably generate a required frequency conversion in the system's RF hardware transceivers with necessary feedback to self-sustain oscillation, and sufficient gain to overcome losses in the feedback path and a resonator. In a preferred embodiment, the system oscillator may develop RF power and low-phase noise for a clean RF signal in the system's transceivers, transmitters, and receivers.

In a preferred embodiment, the system hardware comprises RF amplifiers for the amplification of power in the system radio circuitry hardware and integrated circuits and to drive the system antenna of the transmitter. The RF amplifiers are preferably connected to onboard power supplies, such as rechargeable lithium-ion batteries. The system amplifiers will preferably have appropriate gain, bandwidth control, stability, and signal noise filtering for the application of presently described system. For the presently described application, the power amplifiers will preferably provide output power on the magnitude of 100mW or more for a strong enough signal between the system RF dongle hardware and dog collar. The amplifiers will preferably amplify the incoming RF signal in a linear manner without introducing significant distortion in the amplitude and phase of the signal. The system RF signals are preferably given a positive offset bias to create a bias voltage at the emitter and a bias current through a resistor or inductor. A capacitor is provided to eliminate dc bias from the load and produce an appropriate output alternating current RF signal. The amplifier circuit may preferably use a parallel resonant LC circuit to provide a narrow bandwidth RF constant current source. The system amplifier may preferably use a symmetric transformer coupled push pull circuit with a center tapped driver transformer to supply any required opposite polarity signals. Additionally, the amplifier may use capacitors to charge half the supply voltage and form an artificial center tap for the onboard rechargeable lithium-ion battery power supply. The system RF amplifier may preferably be embodied in a circuit design with a transistor and a parallel resonant RLC circuit, where the transistor pulls the current from the load, and the LC circuit maintains the RF signal waveform. Alternatively, the system amplifier circuit may be embodied in a design where the input and output matching circuits transform the impedance at the source to the load impedance. The system RF amplifier may preferably comprise an input matching network, a transistor, and an output matching network. In a preferred embodiment, the RF amplifier features 433 MHz, 2.4 GHz operational bandwidth, ultra low noise, bias adjustability, linearity optimization in a small integrated circuit package for mobile applications.

The system's RF hardware may preferably comprise a radio frequency transmitter in both the RF dongle and the dog collar module for the transmission (Tx) of RF waves and signals for sending distance ranging signals, data transmission, GPS signal, and other information. The transmitter may preferably function for RF signal modulation and accuracy, frequency conversion, frequency spectrum purity for 433 MHz, 2.4 GHz, and other desired frequencies, and high RF power amplification, efficiency, and output. The system transmitter may preferably be embodied in a signal input, oscillator, multiplier mixer, linear RF power amplifier, and antenna. The system may preferably develop input signal voltage with a high power RF amplifier. The system transmitter may preferably receive input data from the mobile application, signal ranging data, or GPS module, and convert with a digital signal processor to RF signal, or digital analog converter, bandpass filter the signal, RF power amplify and transmit the signal by the antenna. Voltage controlled oscillators may preferably convert the input signal to the bandpass filter, mixer, power amplifier, lowpass filter and transmission over antenna. The transmitter may preferably comprise an input, transducer, power amplifier, modulator, mixer, oscillator, intermediate frequency filter, RF amplifier and antenna. The transducer preferably converts the input signal source into an electrical signal and the modulator codes the information (for demodulation on the dog collar receiver), and may utilize amplitude, frequency, phase, frequency division multiple access, time division multiple access, or code division multiple access modulation techniques for encoding the carrier wave. The mixer preferably functions to raise the carrier frequency of the RF signal, and translates the message information to a much higher frequency and wavelength size for transmission on a appropriate antenna of size and configuration to fit the RF dongle and dog collar hardware. The system oscillator is preferably designed with low phase noise, low drift, and tuned to 433 MHz, 2.4 GHz or other frequencies appropriate for transmission, distance ranging, and sending GPS information and other system data. A preferred embodiment of the system oscillator is an electromechanical quartz crystal frequency generator, or dielectric resonator. The system hardware's RF frequency filter is preferably provided to eliminate unwanted frequencies as developed by the mixer. The RF power amplifier may preferably comprise a high efficiency design for mobile devices and where the internal output impedance is small relative to the external load.

The system may preferably comprise a radio frequency receiver in both the RF dongle and the dog collar module for the receiving (Rx) of RF waves and signals for distance ranging signals, data transmission, GPS signal, and other information. The system receivers may preferably function with appropriate gain, dynamic range, sensitivity, and selectivity for the interception of the system transmitted RF power at distances of up to one-half a mile. The main function of the system receivers is for the amplification and demodulation of the 433 MHz, 2.4 GHz, or other system frequencies with low power consumption. The receiver may comprise of an antenna, tuner, variable inductor-capacitor (LC) circuits, diodes, detectors, amplifiers, bandpass filters, and signal output interface. The system receiver may comprise an antenna, low noise amplifier, and converter to intermediate frequency range. In another preferred embodiment, the system receiver may comprise an antenna, filter, low noise amplifier, mixer, intermediate frequency filter, amplifier, demodulator, low pass filter, power amplifier, and transducer, signal output or digital to analog converter. In another preferred embodiment, the receiver may receive the system signal by an antenna, filter with a bandpass filter, amplify with an low-noise amplifier, convert to intermediate frequency with a mixer and voltage controlled oscillator, channel select filter, analog to digital converter, and digital signal processor for demodulation, decoding, and output to device interfaces. In a preferred embodiment, the system RF receiver is tuned to the center frequency of the bandpass filters to maintain proper bandwidth at the desired operating frequencies of 433 MHz, 2.4 GHz, or other system frequencies. The RF hardware may preferably be comprised of fixed tuned, single frequency receivers with frequency converter front-end mixers and oscillators for signal shift to the system's intermediate frequency. The system receiver may preferably comprise an antenna, mixer, oscillator, intermediate frequency bandpass filter, amplifier, detector, diodes, power amplifier, and signal output interface, or digital to analog converter. The system preferably provides frequency selectivity with fix-tuned bandpass filters in the intermediate frequency amplification range. Additionally, the receiver may employ a positive feedback design between the antenna input and the output for high gain and output power. In a preferred embodiment, the system receiver may comprise a multiple frequency conversion design of the intermediate frequency signal with intermediate frequency bandpass filters, amplifiers, and crystal oscillators with low phase noise. The system receiver may preferably shift the frequency of the system RF signal to baseband by mixing and lowpass filtering with oscillator signals to preserve signal information. In this respect, the system receiver may preferably embody a single chip direct conversion design with an oscillator, mixer, lowpass filter, and digital or analog demodulator.

In another preferred embodiment, the system RF hardware may comprise a transceiver for transmitting (Tx) and receiving (Rx) RF waves and signals for distance ranging signals, data transmission, GPS signal, and other information. The transceiver may preferably function with a shared multi-function oscillator and antenna for the receiver and transmitter with a switch to alternate between the receive and transmit modes. Alternatively, the transceiver may comprise an antenna for the transmit circuitry and another separate antenna for the receiver. With respect to the receiving circuitry, the transceiver may preferably comprise an antenna, single pole double throw switch, RF bandpass filter, low noise amplifier, filters, mixer, voltage controlled oscillator, channel select filter, analog to digital converter, digital signal processor, and signal output interface to the system mobile application, or associated hardware. With respect to the transmission circuitry, the transceiver may comprise an antenna, switch, power amplifier, low pass filter, mixer, voltage controlled oscillator, lowpass filter, digital to analog converter, digital signal processor, and signal input interface from the system mobile application, GPS module, or other associated hardware. In preferred embodiment, the system RF transceiver may comprise input data, formatting, source encoding, encryption, channel encoding, modulation, frequency spreading, and transmission over the antenna. With respect to receiving, the system may comprise receive over the antenna, provide frequency despreading, demodulation, channel decoding, decrypting, source decoding, formatting, and information or data output.

In a preferred embodiment, the RF dongle and dog collar module may comprise microcomputer hardware which may be embodied in a system on a chip (SoC) design, with a micro-controller, processor (CPU), memory (RAM, DRAM, SRAM), storage disk space for saving, reading, writing and accessing data in the form of flash memory or other non-volatile media (Flash, ROM), with an integrated rechargeable power supply, such as a lithium-ion battery, and may comprise at least one peripheral charging port, data port, USB port, micro USB port, or other device port for recharging the integrated power supply or flashing the device with software updates, operating system updates, ROMs, or other data. The system hardware may comprise network connectivity for Bluetooth pairing to a mobile device, or Wi-Fi connection to a wireless computer network. A receiver for GPS signal is preferably provided on the dog collar module for activity and location tracking. The system hardware may comprise tangible computer readable medium comprising processor executable code. In a preferred embodiment, when executed by a processor, the processor-executable code may cause the processor to perform certain operations. In a preferred embodiment, the operations may include RF signal transmission, RF signal receiving, RF signal distance ranging, GPS signal transmission, GPS signal receiving, wireless data transmission, wireless data receiving. The system processor may read, write, or execute computer software, code, or data from a data storage device. The system hardware may preferably run embedded software, a real time operating system, or firmware for the specific RF hardware implementation described here.

The electronic dog collar module preferably includes hardware for providing various stimulus modalities and intensities to the dog. The electronic module plastic waterproof enclosure includes at least one or more electrodes that make contact with the dog for providing electrical shock stimulus. The electrodes are wired to a DC high voltage generator, inverter transformer, or other high voltage electrostatic generating module. The amount of high voltage intensity is variable with a solid-state semiconductor MOSFET switch. The vibrational stimulus modality is provided with an small DC voltage vibrational motor. Audio stimulus may be provided with audio piezo transducer, electroacoustic transducer, or other loudspeaker device. Two-way communications are provided with a microphone and a loudspeaker. Visual stimulus may be provided with LED lights.

In a preferred embodiment, the system provides a mobile device or smartphone application for use with the invisible leash electronic dog collar system may be embodied in a freely available and downloadable iPhone, Android, or Windows Mobile application. The dog owner will use his or her mobile device or smartphone to download and run the invisible leash RF electronic dog collar system application and user interface. The application and user interface preferably allows the dog owner to configure the system settings; to adjust the variable stimulus modalities and intensities; and to define the radius distance. The app. may be written in Objective-C, Java, HTML, CSS, JavaScript, or other high-level programming language and available for download in the iTunes App Store, Google Play Store, or elsewhere on the internet. App. settings and data may be stored in server-side databases, client-side databases, or offline application caches.

In an preferred use case scenario of the presently described RF leash system, the dog owner may attach the electronic dog collar module to the owner's dog and go for a walk. The dog owner defines the radius distance in the mobile device running the invisible leash system application user interface. For example, the radius distance may be set to 25 ft. with the “Radius” slider button horizontally movable slide-able thumb point in the mobile application user interface. The dog will then be confined to this pre-set user-defined distance during the walk. As the dog owner traverses a path, the system will track the dog's distance using RF distance ranging, and the dog will be trained to stay within the user-defined radius by variable stimulus modalities and intensities provided by the electronic dog collar module. For example, the dog may be stimulated with vibrational or electro-shock stimulus to encourage staying near the owner within the user-defined radius during the walk. In this regard, the system functions as an invisible leash to train the dog to stay near the owner while the owner is moving about on a walk.

In a preferred embodiment of the system, the dog owner may set the distance that the dog is allowed to travel away from the owner and set the appropriate stimulus modality and intensity to be applied through the mobile device application user interface. The dog owner accesses the mobile device application user interface and interacts with a “slider” button to set the distance for the dog at 50-feet. The system may alternatively function with distance settings from zero to one-half a mile (˜2,600 feet) away. The slider button may be embodied in a horizontal sliding scale graphical user interface button. The “Radius” or “Distance” slider button may show the available distance setting from zero thru 2,600 feet along the horizontal sliding scale, with increments at every 10 feet, and the actual setting represented with a horizontally movable round slide-able dot or thumb point. The color of the horizontal scale may be varied on either side of the thumb point to increase contrast and readability. In a preferred embodiment, the slider button in the user interface may be set from 0 feet to one-half a mile (i.e., ˜2,600 feet). The dog owner may preferably select a mild electrical shock shall be applied when the dog collar approaches the 50 foot radius boundary and a firm electrical shock when the dog collar reaches the 100 foot distance. The dog owner may additionally set up automatic notifications and alerts to be displayed on the mobile device when the dog reaches the predefined distance boundaries. In a preferred embodiment, the system RF hardware and distance ranging provides a live, real-time streaming distance measurement to the dog on the owner's mobile device application. In a preferred embodiment, the electronic dog collar module will track activity and location information via GPS receiver and transmit this data to the dog owner's mobile device via the RF dongle hardware.

With the use of presently described RF distance ranging system, the invisible leash RF electronic dog collar system will then apply effective stimulus modalities and intensities to the dog in order to correct and control the animal's location and behavior. For example, if the system determines that the dog has traveled outside and beyond the predetermined radius or distance as set by the dog owner, the electronic dog collar may apply an electrical shock stimulus to stop and arrest the animal's movement. The system preferably function to control and confine the dog's movement to a predefined distance or radius as set by the dog owner in the system mobile application user interface. The RF distance ranging hardware and software automatically determines the dog's distance away from the owner via continuous RF distance measurements. Upon reaching the predefined maximum distance, radius or boundary limit, the system provides a correction stimulus to train the dog to stay within the perimeter boundary.

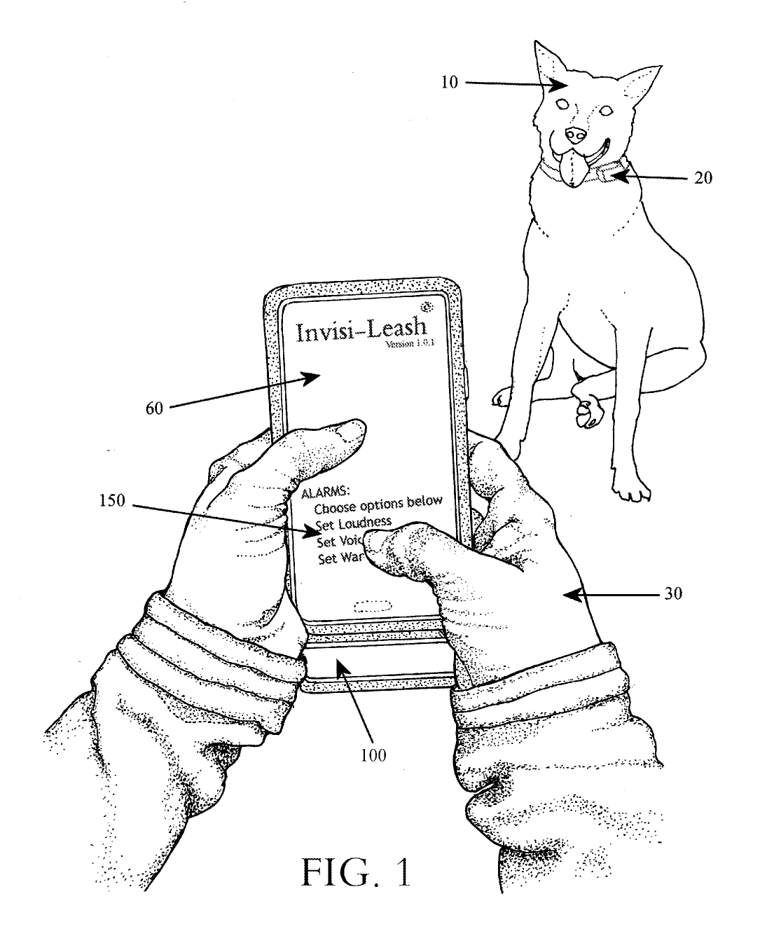

In FIG. 1 a preferred embodiment of the invisible radio frequency (RF) leash system is shown. The owner 30 is operating the mobile device application and user interface 40 for configuring and adjusting the system settings 150, distance, radius, correction stimulus modality (i.e., electric shock, vibration, audible cue), and notifications and updates. The system radio frequency (RF) smartphone dongle 100 is connected to the owner's mobile device 40 for transmitting and receiving system radio frequencies of 433 MHz, 2.4 GHz, or other frequencies. The owner's dog 10 is obediently staying within the predefined distance or radius as set by the owner 30 in the mobile device application 40, 150. The dog 10 is wearing the electronic dog collar module 20 for applying correction stimulus as predefined and configured by the mobile device application user interface 40, 150.

In a preferred embodiment, the owner 30 sets the maximum distance, radius, or perimeter boundary for the dog 10. The correction stimulus modalities may additionally be configured 150 in the mobile device application 60. The system RF dongle 100 transmits and receives distance ranging radio signals to the electronic dog collar module 20 in order to continuously and automatically update the dog's precise distance measurement from the owner 30 with handheld mobile device 60. The system is preferably mobile and may be operated outdoors, across other locations and while walking or hiking with a distance range of up to one-half a mile. The system automatically applies a correction stimulus via the electronic dog collar module 20 when the dog reaches the maximum predefined distance, radius, or perimeter boundary. In this respect, the dog is safely controlled and confined to the area setup by the owner. Additionally, the system is fully mobile and continuously updates distance ranging information and perimeter boundary as the owner and dog move about from location to location. The RF dongle and dog collar module also receives GPS location and activity tracking data and transmits this information across the system data-link between the dog collar and RF dongle with interface to the owner's mobile device and system application user interface.

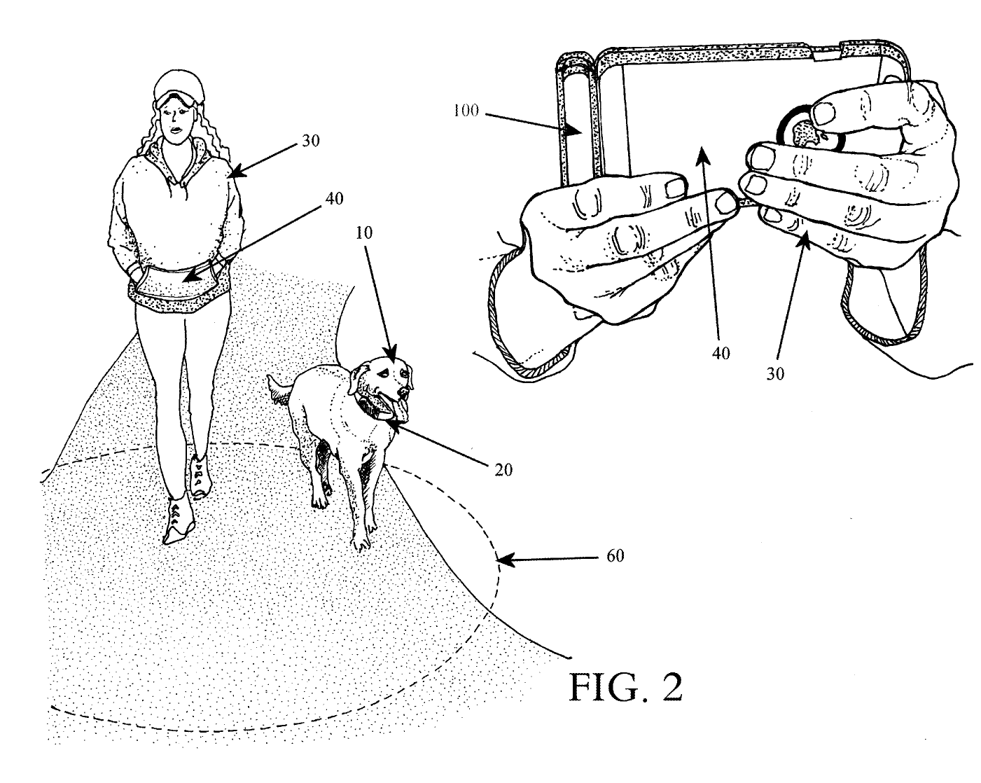

In FIG. 2 the owner 30 is fully mobile and using the invisible RF leash system 40, 20 for taking her dog 10 for a walk and ensuring that the dog remains within a predefined distance or radius. The dog 10 is wearing the invisible leash electronic dog collar module 20 and is confined to the user-defined radius 60. As the system is fully mobile, the owner 30 and dog 20 traverse the outdoor path and the system continuously and automatically updates the distance ranging information for a mobile perimeter boundary 60, which follows the dog and owner. The owner 30 may update and configure the system settings, distance, radius, perimeter boundary, stimulus modalities, and updates & notifications via the mobile device 40 running the system application and user interface. The RF dongle 100 connects to the owner's mobile device 40 and continuously transmits and receives 433 MHz, 2.4 GHz, or other radio frequencies to the electronic dog collar module 20 for a precise distance measurement. As described in this application, the distance ranging calculation is preferably done by speed of light and stopwatch timing for the RF signal between the dongle and dog collar. Additionally, GPS location and activity tracking data is received on the dog collar and transmitted to the RF dongle via the system data-link and provided and displayed on the owner's mobile device application user interface. With a fully mobile perimeter boundary, the dog's 10 distance or radius from the owner 30 is automatically confined with correction stimulus from the dog collar module. The dog 10 is safely controlled with the system invisible RF leash functionality to stay near the owner 30 during walking, running, or moving about.

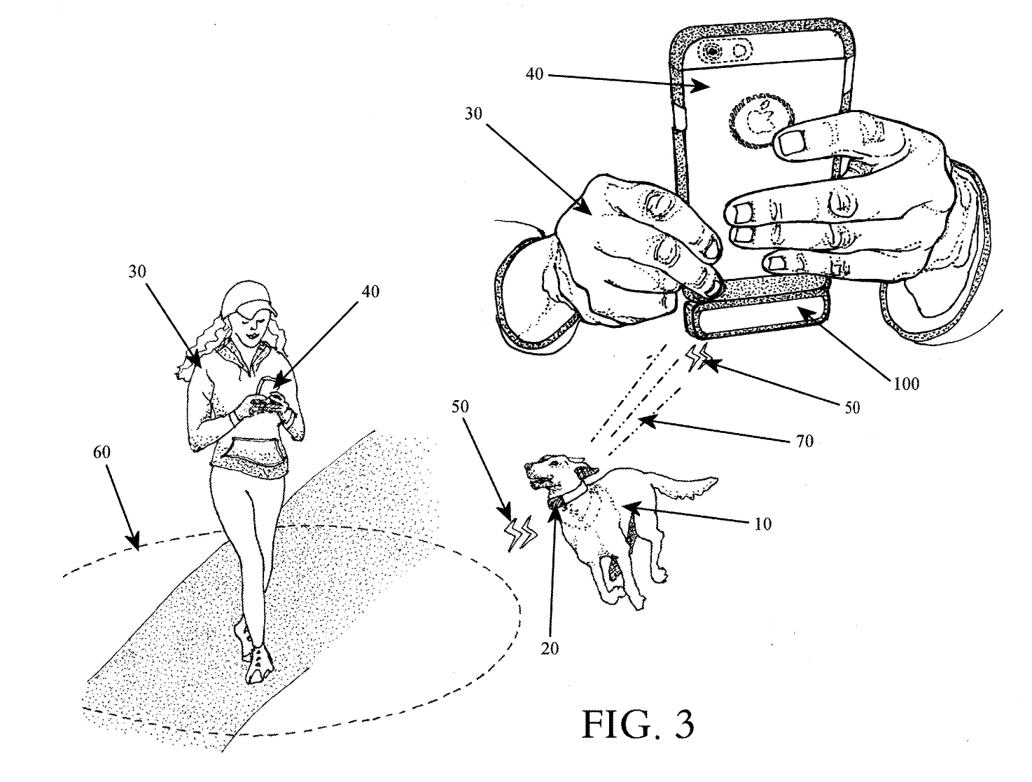

In FIG. 3 the owner 30 receives automatic distance information, notifications, and updates on the system mobile device application user interface 40. The distance ranging signal is transmitted and received between the system RF dongle 100 to the dog collar module 20. The owner 30 and dog 10 are fully mobile and able to walk, run and move about while using the presently described invisible RF leash system while keeping the dog within the predefined distance, radius or perimeter boundary 60. The invisible RF leash system preferably operates on 433 MHz, 2.4 GHz, or other radio frequencies 70 for transmitting and receiving a distance ranging signal, data-link, system settings, configurations, GPS signal, and location and activity tracking information between the RF dongle 100 and dog collar 20. The system may preferably be configured, via the mobile device application 40, to provide an electric shock or other correction stimulus 50 to the dog 10 with the dog collar 20, when the dog 10 reaches the maximum predefined distance, radius, or perimeter boundary 60.

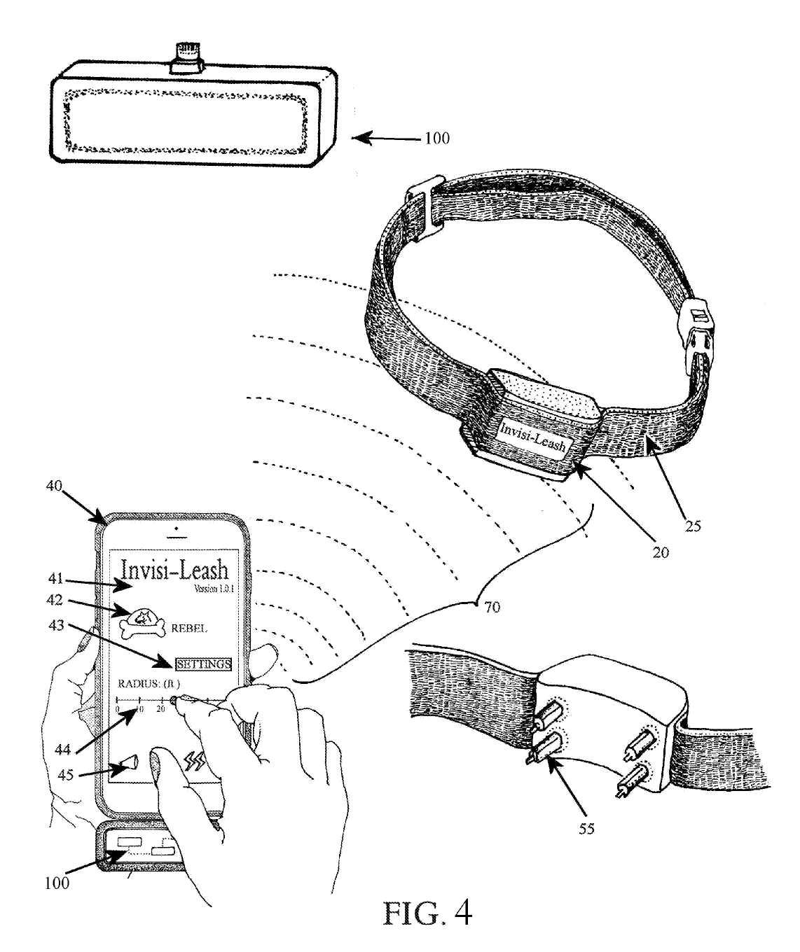

In FIG. 4, the invisible RF leash system components are shown. The radio frequency (RF) hardware dongle and mobile device interface is shown 100 for connecting to the owner's smartphone or other mobile device 40. In a preferred embodiment, the RF dongle 100 integrates and connects with the mobile device 40 port, lighting port, USB port, or other port type, or may alternatively wirelessly connect to the owner's mobile device with Bluetooth or Wi-Fi pairing. The RF dongle houses radio hardware for transmitting and receiving distance ranging signals, data-link, system settings, correction stimulus settings, distance, radius or perimeter boundary settings, GPS signal, and activity & location tracking information 70 between the dog collar 20 and the owner's mobile device 40. The dog collar 20 and RF dongle 100 preferably transmit and receive RF signals at 433 MHz, 2.4 GHz, or other frequencies 70, with a distance range and signal power of up to one-half a mile. The dog is confined and controlled with electrical shock correction stimulus via electrodes 55 on the dog collar module 20, 25. The dog collar may preferably be constructed with a lightweight, breathable, synthetic nylon webbing material 25. In the system mobile device application user interface 41, the dog profile 42 is shown for configuring and storing unique dog profile settings 43. The system distance or “RADIUS” 44 may be configured with a horizontally movable, slide-able dot or thumb point, with units of measurement in feet, meters, or other units. The dog collar stimulus modalities 45 (i.e., electric shock, vibration, audible cue) may be adjusted and configured with respect to intensity, duration, or pattern, via the system mobile device application user interface 41.

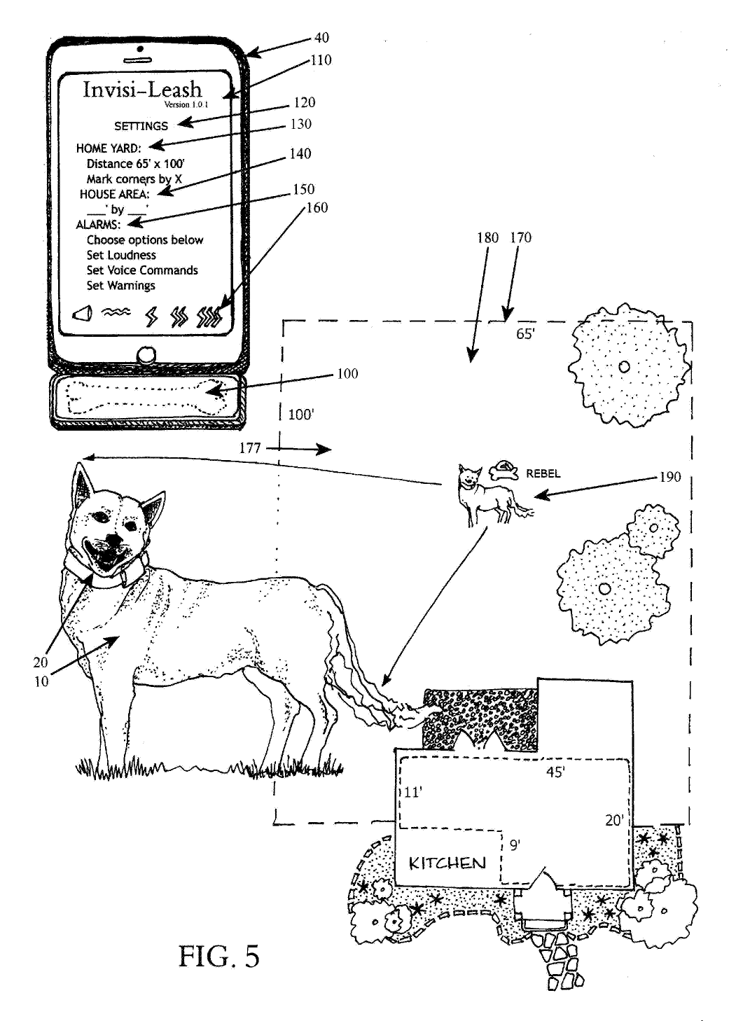

FIG. 5 is a view of the invisible RF leash system in a preferable use case scenario at the owner's home or residential area. The dog 10 is confined and controlled within the perimeter boundary 170 and backyard area 180 with the electronic dog collar module 20. The owner configures the system settings 120 with the mobile device 40 running the system application 110. The system settings for the “HOME YARD” profile 130 are displayed with settings for distance, radius, dimensions, perimeter boundary sizes, etc., 140. System alarms 150, loudness, voice commands, warnings, notifications and updates may be configured for delivery at the system dog collar 20. Correction stimulus may be configured for electric shock, vibration, audible cue, as well as intensity, duration, pattern, etc., 160. The system mobile device application 110 links to the system RF dongle 100 for transmission and receipt of distance ranging signal, system configurations, correction stimulus settings, data-link, GPS data, and location and activity tracking information between the dongle 100 and collar 20. In a preferred embodiment, the owner's dog 190 is safely and reliably confined and controlled to stay with the predefined perimeter boundary 170 and backyard area 180, 177. The system does not require a complicated setup and adjustment process and is immediately usable when deployed in the owner's home or backyard area 180.

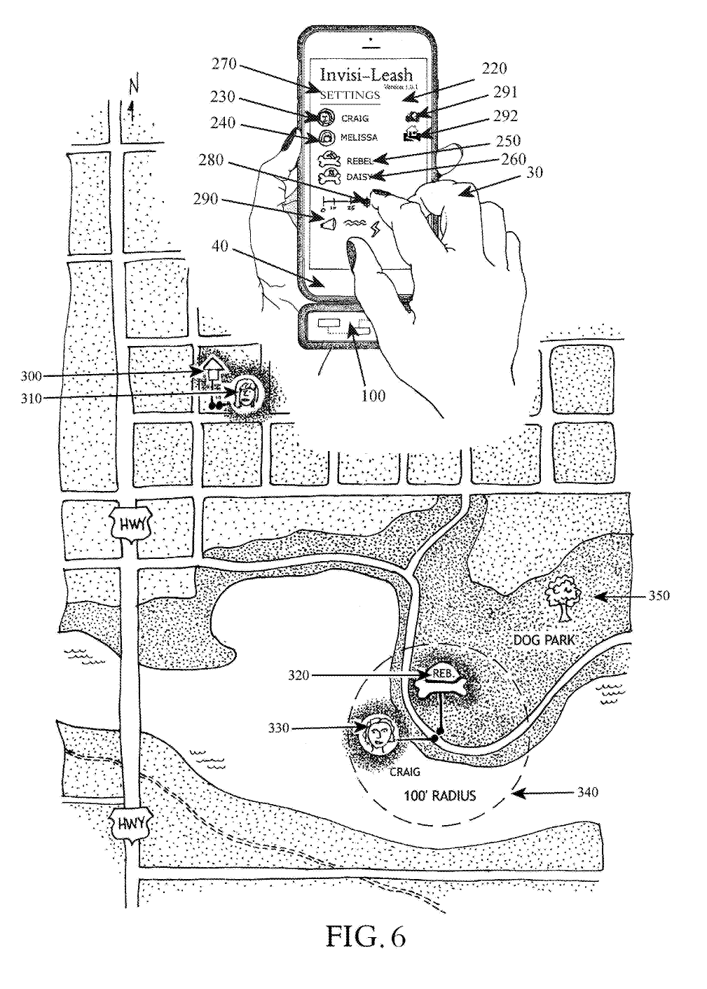

FIG. 6 is a view of the invisible RF leash system in a preferable use case scenario at the dog park 350 and showing the system map overview with GPS location integration. The dog owner's mobile device or smartphone 40 is running the system application user interface 220, displaying unique user profiles 230 and 240, and unique dog profiles 250 and 260. In a preferred embodiment, the dog and user profiles store system settings, configurations, and location and activity tracking data. The system application may save and store settings for multiple unique user or dog profiles. The settings 270 may be adjusted and configured for each profile. The horizontal slider movable thumb point 280 may be adjusted to define the radius, distance, or perimeter boundary to train and confine the dog 320. The radius is defined as a “100′ RADIUS” 340. Audible, vibrational, or electrical stimulus correction modalities and intensities 290 are configured in the user interface and may correspond and be applied at the radius distance 280. The application user interface may display the local area map of the “DOG PARK” 350 and surrounding areas with overlays for the home location 300, dog owner location 310, dog walker location 330 and the dog's location 320. The dog's location 320 is determined with GPS location data and system RF 433 MHz, 2.4 GHz, or other radio frequency ranging.

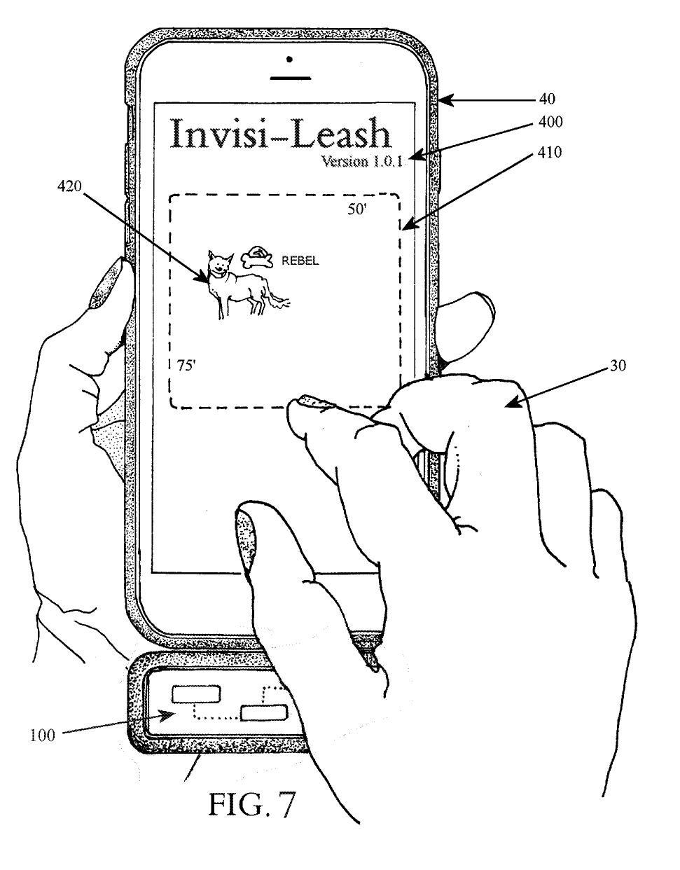

FIG. 7 is a view of a preferred embodiment of the user-defined perimeter boundary functionality in the mobile device application user interface 400. The user 30 preferably defines a home space or local area map boundary 410 by drawing, or dragging and manipulating the perimeter boundary lines in the application 400. The user may “draw” on the mobile device application user interface with his or her hand 30 a rectangular, square or other shaped perimeter boundary line 410 to train and confine the dog 420. The dog's location 420 is displayed on the mobile device 40 with data obtained from the system RF dongle 100 and dog collar distance ranging signal and GPS location and activity tracking information. In a preferred embodiment, the user-defined perimeter boundary, distance or radius may alternatively be configured with a “RADIUS” or “DISTANCE” slider button, with an incremental distance scale represented with a horizontally movable, slide-able dot or thumb point.

1. An invisible radio frequency (RF) leash system for controlling and confining an owner's dog to a predefined distance or radius comprising:
a radio frequency (RF) mobile device dongle;
an electronic dog collar module; and
a mobile device application user interface;
wherein the RF dongle comprises radio hardware to transmit and receive 433 MHz, 2.4 GHz, or other radio frequency distance ranging signals to the electronic dog collar module; wherein the mobile device application user interface allows the dog owner to configure distance, radius, or perimeter boundary and correction stimulus settings; and wherein the system is fully mobile and the dog is automatically controlled and confined to the maximum distance, radius, or perimeter boundary with correction stimulus and the dog remains within the perimeter.

2. The invisible radio frequency (RF) leash system for controlling and confining an owner's dog to a predefined distance or radius of claim 1, wherein the RF dongle and dog collar module continuously transmit and receive distance ranging signals by the system RF transmitter, RF receiver, frequency generator, frequency counter integrated circuit, and determine continuously updated real-time distance measurement with speed of light and clock time calculation.

3. The invisible radio frequency (RF) leash system for controlling and confining an owner's dog to a predefined distance or radius of claim 1, wherein the RF hardware is provided with frequency generators and counters with clock frequencies of 100 MHz and above for distance calculation precision within plus or minus five feet.

4. The invisible radio frequency (RF) leash system for controlling and confining an owner's dog to a predefined distance or radius of claim 1, wherein the system RF hardware transmits and receives RF distance ranging signals, system configurations, settings, stimulus modalities, duration, patterns, and GPS signal location and activity tracking information between the dog collar and the RF dongle.

5. The invisible radio frequency (RF) leash system for controlling and confining an owner's dog to a predefined distance or radius of claim 1, wherein the RF hardware dongle may be paired to the user's mobile device with a lighting port, USB port, data port, plug, cable or other physical connection or paired wirelessly over Bluetooth or Wi-Fi.

6. The invisible radio frequency (RF) leash system for controlling and confining an owner's dog to a predefined distance or radius of claim 1, wherein the dog collar comprises a GPS module for activity tracking and location information for transmission to the RF dongle and display on the system mobile device application user interface.

7. The invisible radio frequency (RF) leash system for controlling and confining an owner's dog to a predefined distance or radius of claim 1, wherein the dog owner configures the distance, radius or perimeter boundary within the mobile device application user interface comprising a horizontally movable slid-able dot or thumb point along an incremental scale.

8. An invisible radio frequency (RF) leash method for controlling and confining a dog to a predefined distance, radius, or perimeter boundary comprising:
transmitting a first distance ranging RF signal from a mobile device RF dongle;
simultaneously starting a crystal frequency generator and counter integrated circuit;
receiving the first distance ranging RF signal at an electronic dog collar module;
transmitting a second distance ranging RF signal from the dog collar module to the mobile device RF dongle;
sampling a clock time datapoint from the counter integrated circuit upon receiving the second distance ranging RF signal;
determining the precise distance between the mobile device RF dongle and dog collar module by speed of light, and frequency generator and counter integrated circuit clock time datapoint; and
providing correction stimulus with the electronic dog collar module upon exceeding a maximum distance, radius or perimeter boundary setting as configured in a system mobile device application user interface;
wherein the distance measurement is continuously updated and monitored in real-time by the system mobile device application for for automatically controlling and confining the dog within the perimeter boundary.

9. The invisible radio frequency (RF) leash method for controlling and confining a dog to a predefined distance, radius, or perimeter boundary of claim 8, wherein the RF dongle and dog collar module continuously transmit and receive distance ranging signals at 433 MHz, 2.4 GHz, or other frequencies by the system RF transmitter, RF receiver, frequency generator, frequency counter integrated circuit, and determine continuously updated real-time distance measurement with speed of light and clock time calculation.

10. The invisible radio frequency (RF) leash method for controlling and confining a dog to a predefined distance, radius, or perimeter boundary of claim 8, wherein the RF hardware is provided with frequency generators and counters with clock frequencies of 100 MHz and above for distance calculation precision within plus or minus five feet.

11. The invisible radio frequency (RF) leash method for controlling and confining a dog to a predefined distance, radius, or perimeter boundary of claim 8, wherein the system RF hardware transmits and receives RF distance ranging signals, system configurations, settings, stimulus modalities, duration, patterns, and GPS signal location and activity tracking information between the dog collar and the RF dongle.

12. The invisible radio frequency (RF) leash method for controlling and confining a dog to a predefined distance, radius, or perimeter boundary of claim 8, wherein the RF hardware dongle may be paired to the user's mobile device with a lighting port, USB port, data port, plug, cable or other physical connection or paired wirelessly over Bluetooth or Wi-Fi.

13. The invisible radio frequency (RF) leash method for controlling and confining a dog to a predefined distance, radius, or perimeter boundary of claim 8, wherein the dog collar comprises a GPS module for activity tracking and location information for transmission to the RF dongle and display on the system mobile device application user interface.

14. The invisible radio frequency (RF) leash method for controlling and confining a dog to a predefined distance, radius, or perimeter boundary of claim 8, wherein the dog owner configures the distance, radius or perimeter boundary within the mobile device application user interface comprising a horizontally moveable slid-able dot or thumb point along an incremental scale.

15. An invisible radio frequency (RF) leash system for controlling and confining a dog to a predefined radius, distance, or perimeter boundary comprising:
a mobile device application user interface for setting the perimeter boundary;
a mobile device RF hardware interface for transmitting and receiving distance ranging signals, system configuration data, and location and activity tracking information; and
an electronic dog collar module for transmitting and receiving distance ranging signals, system configuration data, and location and activity tracking information;
wherein the dog collar module provide correction stimulus for confining the dog to with the perimeter boundary as determined by the distance ranging signals; and wherein the distance ranging calculation is continuously updated and monitored by the mobile device application.

16. The invisible radio frequency (RF) leash system for controlling and confining a dog to a predefined radius, distance, or perimeter boundary of claim 15, wherein the mobile device RF hardware interface and dog collar module continuously transmit and receive distance ranging signals by the system RF transmitter, RF receiver, frequency generator, frequency counter integrated circuit, and determine continuously updated real-time distance measurement with speed of light and clock time calculation.

17. The invisible radio frequency (RF) leash system for controlling and confining a dog to a predefined radius, distance, or perimeter boundary of claim 15, wherein the system RF hardware transmits and receives RF distance ranging signals, system configurations, settings, stimulus modalities, duration, patterns, and GPS signal location and activity tracking information between the dog collar and the RF dongle.

18. The invisible radio frequency (RF) leash system for controlling and confining a dog to a predefined radius, distance, or perimeter boundary of claim 15, wherein the RF hardware is provided with frequency generators and counters with clock frequencies of 100 MHz and above for distance calculation precision within plus or minus five feet.

19. The invisible radio frequency (RF) leash system for controlling and confining a dog to a predefined radius, distance, or perimeter boundary of claim 15, wherein the dog collar comprises a GPS module for activity tracking and location information for transmission to the RF hardware and display on the system mobile device application user interface.

20. The invisible radio frequency (RF) leash system for controlling and confining a dog to a predefined radius, distance, or perimeter boundary of claim 15, wherein the dog owner configures the distance, radius or perimeter boundary within the mobile device application user interface comprising a horizontally moveable slid-able dot or thumb point along an incremental scale.
